(19) United States
(12) Patent Application Publication
(10) Pub. No.: US 2013/0325594 A1
(43) Pub. Date: Dec. 5, 2013

(54) SPONSORED APPLICATIONS

(71) Applicant: Satish Mehta, Union City, CA (US)

(72) Inventor: Satish Mehta, Union City, CA (US)

(73) Assignee: YAHOO! INC., SUNNYVALE, CA (US)

(21) Appl. No.: 13/488,671

(22) Filed: Jun. 5, 2012

(51) Int. Cl. G06Q 30/02

(52) U.S. Cl. 705/14.46; 705/14.49

(57) ABSTRACT

A computer-implemented method for sponsored applications includes: loading a smart tag with metadata about an application to be downloaded on a user device, said metadata including information about the application that assists an ad server in selecting a targeted advertisement relevant to said application; programming the smart tag to communicate with the ad server requesting service of relevant, targeted ads to the user device based on the metadata once the application is transmitted to the user device and upon each invocation of the application thereafter; and placing the smart tag on the application to be made available for download.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of on-line advertising, and more particularly relates to the field of sponsored advertising applied to a downloaded application.

### BACKGROUND OF THE INVENTION

Currently, there are a tremendous number of applications (apps) that can be downloaded onto computing devices such as mobile phones, tablet computers, and the like. The apps are easily downloaded from an App Store, such as the Android or Apple Store. The standard revenue model for these apps is a one-time charge to the user when the app is downloaded. This model does not provide an on-going revenue stream. Further, the cost of apps, although relatively inexpensive, is an impediment to their viral usage.

There is needed an improved system and method for monetizing app usage.

### SUMMARY OF THE INVENTION

Briefly, according to an embodiment of the invention a method for sponsored applications includes steps or acts of: loading a smart tag with metadata about an application to be downloaded on a user device, said metadata including information about the application that assists an ad server in selecting a targeted advertisement relevant to said application; programming the smart tag to communicate with the ad server requesting service of relevant, targeted ads to the user device based on the metadata once the application is transmitted to the user device and upon each invocation of the application thereafter; and placing the smart tag on the application to be made available for download. The application will be activated only after presentation of the advertisement has completed.

According to another embodiment of the present invention, an information processing system for sponsored applications includes the following: an input-output subsystem for receiving from a user device a request for an application; and a memory with instructions for: loading a smart tag with metadata including information about the application, the information used by an ad server to select advertisements relevant to the application; programming the smart tag to communicate with the ad server, requesting service of targeted ads once the application is transmitted to the user device and upon each invocation of the application thereafter; and placing the smart tag on the application. The system also includes a processor device operably coupled with the memory for executing the computer-executable instructions stored in the memory.

According to another embodiment of the present invention, a computer program product includes a computer-readable storage medium for computer-executable instructions stored therein for executing the steps of: loading a smart tag with metadata about an application to be downloaded on a user device, said metadata including information about the application that assists an ad server in selecting a targeted advertisement relevant to said application; programming the smart tag to communicate with the ad server requesting service of relevant, targeted ads to the user device based on the metadata once the application is transmitted to the user device and upon each invocation of the application thereafter; and placing the smart tag on the application to be made available for download.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a simplified depiction of an information processing system operating according to an embodiment of the present invention;

FIG. 2 is a flowchart of a method for delivering sponsored apps, according to an embodiment of the invention;

FIG. 3 is a high-level block diagram of a computer apparatus configured to operate according to an embodiment of the present invention; and

FIG. 4 is an app valuation report, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe a system and method for combining application (app) invocation with targeted advertising to implement sponsored apps. In this paradigm, the apps can be made available for free because the advertisers will pay for serving advertisements (ads) with the apps. This benefits the users who receive free apps; it benefits the advertisers who are better able to target their ads.

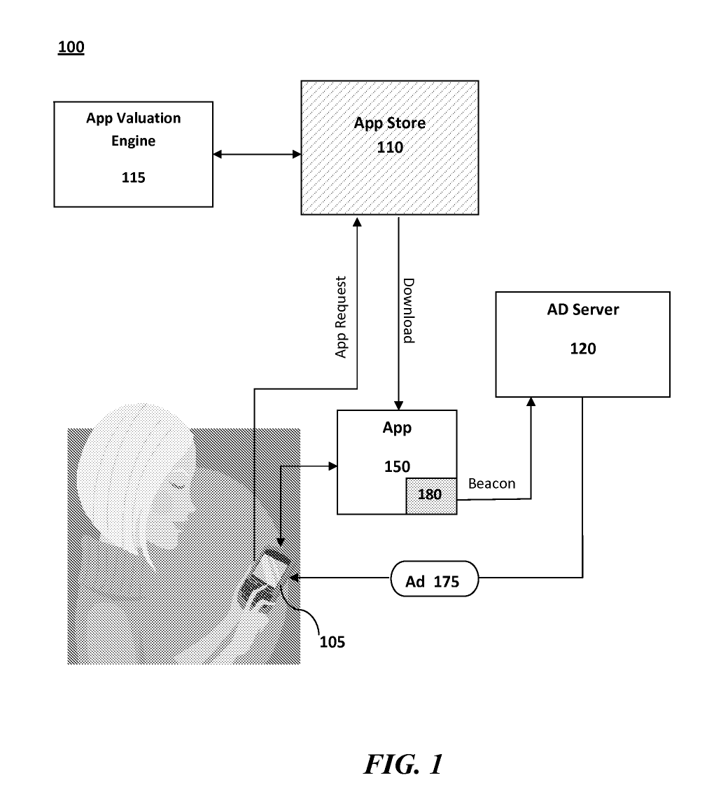

Referring now to the drawings and to FIG. 1 in particular, we show a system 100 in which the method for serving sponsored apps can be implemented. In this system 100, a device 105, such as a mobile phone, is in communication with an App Store 110 for downloading apps onto the mobile phone 105. The device 105 is represented here as a mobile phone but those with knowledge in the art will appreciate that the device 105 can be any device with the ability to store digital information, including a table computer and an Internet-enabled television. The user selects an app 150 to be downloaded on his/her device 105.

The app 150 has an embedded smart tag 180 that calls an Ad Server 120 to serve an Ad 175 to the device 105, before the downloaded App 150 runs. The smart tag 180 contains metadata with information about the App 150 and also information about the user, such that the Ad Server 120 is able to select an Ad 175 targeted for the user. Using a smart tag 180 including metadata is known as intelligent tagging or heavy beaconing. The smart tag 180 provides the Ad Server 120 a larger chunk of information about the user, in addition to the app information that is already loaded in the smart tag 180. The metadata stored in the smart tag 180 is both static and dynamic data. Explaining it further, the App 150 was created with the embedded smart tag 180, so the smart tag 180 will always return the same info about its App 150 (static info). However, every new user downloading the App 150 could be potentially different from the previous one and therefore that information is dynamic and required for targeting ads and therefore, sent to the Ad Server 120. This information could include many things such as demographic info, segmentation information, geo information, user preferences, and the like. Such information thus helps the Ad Server 120 to serve more relevant Ads 175 to the user.

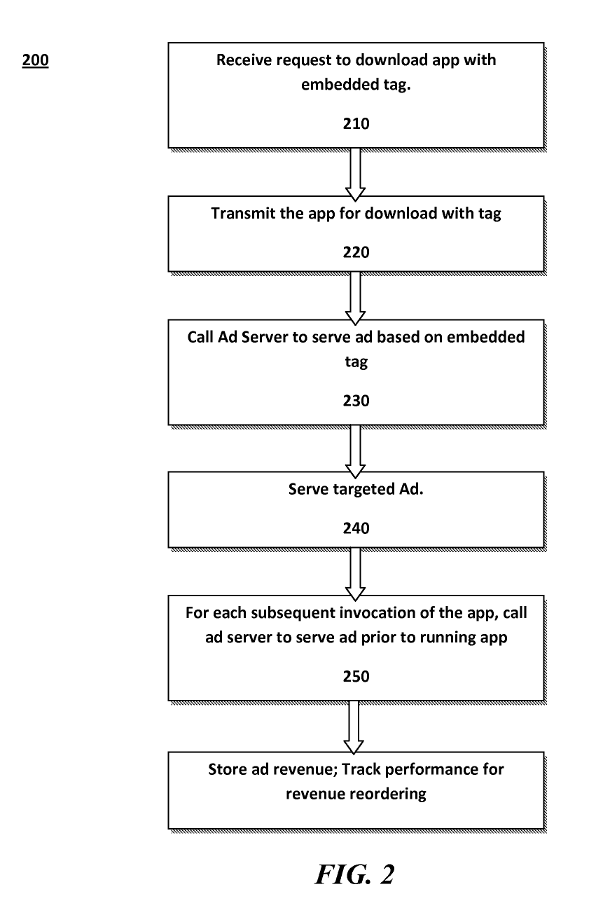

Referring now to FIG. 2 we discuss the process steps for implementing sponsored apps, according to an embodiment of the present invention. First the user selects an App 150 for downloading. The Ad Store 110 receives a request from the user's device 105 to download the App 150. The App 150 is embedded with a smart tag 180. The smart tag 180 allows advertisers and other on-line producers to perform ad targeting.

In step 220 the App 150 is transmitted to the device 105 for download. The smart tag 180, acting as a beacon in this instance, calls the Ad Server 120 to serve an Ad 175 on the user's device. The Ad 175 is selected according to the information provided by the smart tag 180 when it contacts the Ad Server 120. In step 240 the Ad 175 is served on the device 105. Therefore, in step 250, for each subsequent invocation of the App 150, the smart tag 180 calls the Ad Server 120 to serve an Ad 175 prior to running the App 150. The App 150 will not be activated until the Ad 175 has run in its entirety. We contemplate an example of a sponsored App 150 related to a game called “Avataar Mania.” Let's assume the user has downloaded this App 150. As soon as the user attempts to invoke the App 150 in order to play the game, the embedded smart tag 180 notifies the Ad Server 120. Based on the user's segment/targeting info sent to the Ad Server 120 by the smart tag 180, the Ad Server 120 can determine that the user should be served an Ad 175 related to Avataar memorabilia or an Ad 175 for tickets to the new sequel to Avataar. The Ad Server 120 serves the targeted Ad 175 on the user's device. The Ad 175 runs in its entirety while the user is waiting for the game to start. At this point the user is a “captive audience” and is likely to be responsive to the targeted Ad 175.

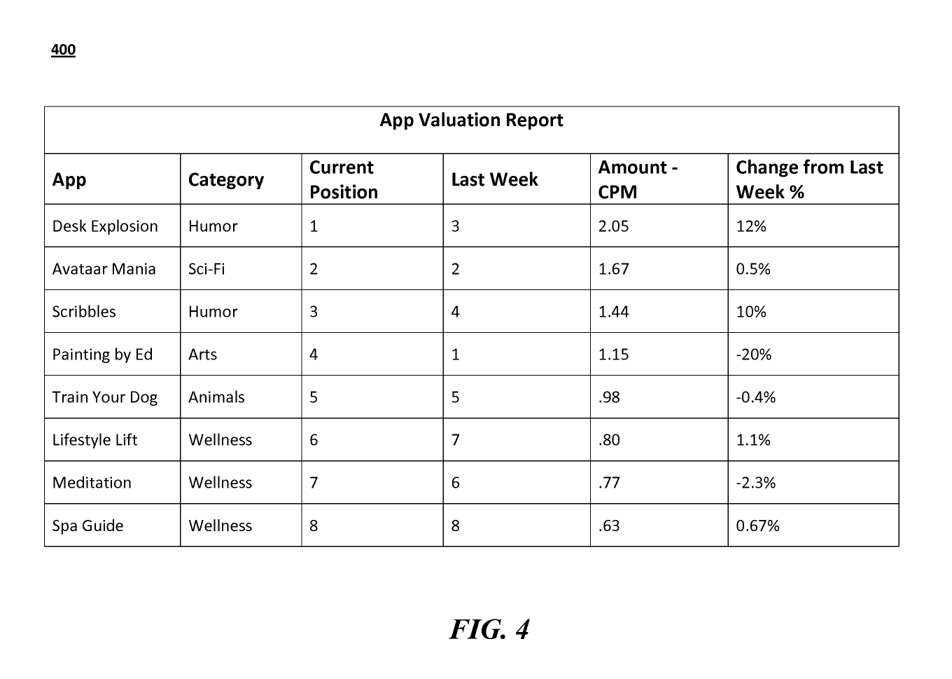

In step 260 we use an App Valuation Engine 115 to collect data on the revenue collected from advertisers for each App 150. This Engine 115 is shown in FIG. 1 as a separate component, but it could be implemented within the App Store 110. Based on the revenue we receive from advertisers for the Apps 150, in one embodiment of the invention, the Engine 115 re-orders the presentation of the Apps 150 in the App Store 110 in order of their performance. We place higher-performing Apps 150 in the most prominent display position. Referring now to FIG. 4 there is shown an exemplary App Valuation Report 400 showing how the different Apps 150 are ranked according to revenue and their ranking displays their display position in the App Store 110. The Apps 150 can be ranked simply by revenue or by revenue within category.

In one embodiment of the invention, each sponsored ad event can be valued at the equivalent of one cost per mille (CPM, or cost per thousand impressions) since the user is shown the Ad 175 for a considerable time. CPM is on-line advertising terminology designating how advertisers pay for exposure of their brand to a specific audience. “Per mille” means per thousand impressions, or loads, of an advertisement. In the case of offline devices, an advertising campaign will download with the first download.

There are many benefits and advantages of the invention: a) the users can receive the apps for free; b) the producers receive a commission from selling the apps to advertisers; c) the producer can receive revenue every time an app is invoked, as opposed to receiving only a one-time download charge; and d) the ads served are more relevant to the user because of the smart tag.

### Hardware Embodiment

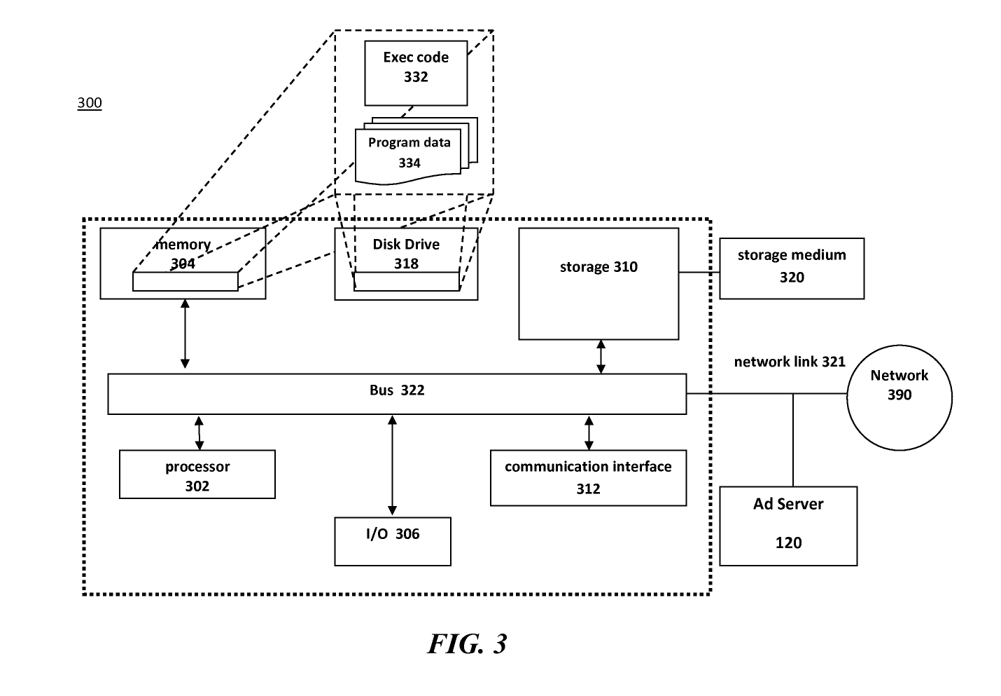

Referring now in specific detail to FIG. 3, there is provided a simplified high-level block diagram of an information processing system 300 for implementing sponsored apps in which the present invention may be implemented. For purposes of this invention, computer system 300 may represent any type of device that has the capability to store digital information, such as a computer, information processing system or other programmable electronic device, including a client computer, a server computer, a portable computer, a tablet computer, an embedded controller, a personal digital assistant, Internet TV, the Cloud, and so on. The computer system 300 may be a stand-alone device or networked into a larger system. Computer system 300, illustrated for exemplary purposes as a networked computing device, is in communication with other networked computing devices (not shown) via network 390. As will be appreciated by those of ordinary skill in the art, network 390 may be embodied using conventional networking technologies and may include one or more of the following: local area networks, wide area networks, intranets, public Internet, Cloud Computing and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 300, for simplicity. As will be appreciated by those of ordinary skill in the art, aspects of the invention may be distributed among one or more networked computing devices which interact with computer system 300 via one or more data networks such as, for example, network 890. However, for ease of understanding, aspects of the invention have been described as embodied in a single computing device—computer system 300.

Computer system 300 includes processing device 302 which communicates with an input/output subsystem 306, memory 304, storage 310 and network 390. The processor device 302 is operably coupled with a communication infrastructure 322 (e.g., a communications bus, cross-over bar, or network). The processor device 302 may be a general or special purpose microprocessor operating under control of computer program instructions 332 executed from memory 304 on program data 334. The processor 302 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 304 may be partitioned or otherwise mapped to reflect the boundaries of the various memory subcomponents. Memory 304 may include both volatile and persistent memory for the storage of: operational instructions 332 for execution by processor device 302, data registers, application storage and the like. Memory 304 may include a combination of random access memory (RAM), read only memory (ROM) and persistent memory such as that provided by a hard disk drive 318. The computer instructions/applications that are stored in memory 304, such as instructions for implementing the steps of FIG. 2, are executed by processor 302. The computer instructions/applications 332 and program data 334 can also be stored in hard disk drive 318 for execution by processor device 302. The Ad Server 120 pictured here is a representation of a plurality of servers operably coupled within a server network such as the Internet through network link 321.

Those skilled in the art will appreciate that the functionality implemented within the blocks illustrated in the diagram may be implemented as separate components or the functionality of several or all of the blocks may be implemented within a single component. The I/O subsystem 306 may comprise various end user interfaces such as a display, a keyboard, and a mouse. The I/O subsystem 306 may further comprise a connection to a network 390 such as a local-area network (LAN) or wide-area network (WAN) such as the Internet.

The computer system 300 may also include storage 310, representing a magnetic tape drive, an optical disk drive, a CD-ROM drive, and the like. The storage drive 310, which can be removable, reads from and/or writes to a removable storage unit 320 in a manner well known to those having ordinary skill in the art. Removable storage unit 320, represents a compact disc, magnetic tape, optical disk, CD-ROM, DVD-ROM, etc. which is read by and written to by removable storage drive 310. As will be appreciated, the removable storage unit 320 includes a non-transitory computer readable medium having stored therein computer software and/or data for implementing the real-time feedback collection system.

The computer system 300 may also include a communications interface 812. Communications interface 312 allows software and data to be transferred between the computer system and external devices. Examples of communications interface 312 may include a modem, a network interface (such as an Ethernet card), a communications port, a PCMCIA slot and card, etc. Software and data transferred via communications interface 312 are in the form of signals which may be, for example, electronic, electromagnetic, optical, or other signals capable of being received by communications interface 312.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A computer-implemented method for sponsored applications, comprising:
using a processor device, performing:
loading a smart tag with metadata about an application to be downloaded on a user device, said metadata comprising information about said application that assists an ad server in selecting a targeted advertisement relevant to said application;
programming the smart tag to communicate with the ad server requesting service of relevant, targeted ads to the user device based on the metadata once the application is transmitted to the user device and upon each invocation of said application thereafter; and
placing the smart tag on the application to be made available for download;
wherein the application is activated only after the ad completes.

2. The computer-implemented method of claim 1 wherein placing the smart tag comprises embedding the smart tag in the application.

3. The computer-implemented method of claim 1 further comprising:
tracking ad revenue associated with the application.

4. The computer-implemented method of claim 3 further comprising:
re-ordering presentation of applications based on ad revenue received from the applications;
wherein higher revenue-generating applications are displayed more prominently than lower revenue-generating applications.

5. The computer-implemented method of claim 1 further comprising:
activating the application after the ad completes;.

6. The computer-implemented method of claim 1 further comprising:
augmenting metadata in the smart tag with information about the user, wherein said information is used by the ad server to select relevant ads.

7. A computer-implemented method for sponsored applications, comprising:
using an input-output subsystem downloading an app on a user device, wherein said application comprises a smart tag programmed for communication with an ad server for serving ads to said user device; and
using a processor device performing:
transmitting a prompt from the smart tag to the ad server to serve a targeted ad to the user device before the application is invoked, wherein said prompt comprises metadata from the smart tag, said metadata comprising data about the application;
receiving the targeted ad from the ad server;
presenting the targeted ad on the user device; and
activating the application once the targeted ad terminates.

8. The computer-implemented method of claim 7 further comprising:
for each subsequent invocation of the application:
performing the transmitting, presenting, and activating steps.

9. The computer-implemented method of claim 7 further comprising:
augmenting metadata in the smart tag with data about the user; and
transmitting the augmented metadata to the ad server, enabling the targeting of advertising relevant to said user.

10. The computer-implemented method of 7 further comprising tracking ad revenue associated with the invocations of the application.

11. The computer-implemented method of claim 10 further comprising:
re-ordering presentation of applications based on the ad revenue received from the applications;
wherein higher revenue-generating applications are displayed more prominently than lower revenue-generating applications.

12. The computer-implemented method of claim 11 wherein displaying higher revenue-generating applications more prominently comprises displaying said higher revenue-generating applications in sequence before other applications.

13. An information processing system for sponsored applications, comprising:
an input-output subsystem receiving from a user device a request for an application;
a memory with computer-executable instructions stored therein, said computer-executable instructions comprising:
loading a smart tag with metadata comprising information about the application, said information used by an ad server to select advertisements relevant to said application;
programming the smart tag to communicate with the ad server, requesting service of targeted ads to the user device once the application is transmitted to the user device and upon each invocation of said application thereafter;
placing the smart tag on the application to be made available for download;
and
wherein the application is activated only after the ad completes;
and
a processor device operably coupled with the memory, performing the computer-executable instructions.

14. The information processing system of claim 13 wherein the computer-executable instructions further comprise:
an application valuation engine tracking ad revenue associated with the invocations of the application.

15. The information processing system of claim 13 wherein the smart tag is augmented with metadata about the user.

16. The information processing system of claim 14 wherein the computer-executable instructions further comprise:
re-ordering presentation of applications based on the ad revenue received from the applications;
wherein higher revenue-generating applications are displayed more prominently in an ad store than lower revenue-generating applications.

17. The information processing system of claim 14 wherein the computer-executable instructions further comprise tracking the ad revenue by application category.

18. A computer program product comprising a non-transitory computer-readable storage medium with computer-executable instructions stored therein, said computer-executable instructions causing a computer to perform:
loading a smart tag with metadata about an application to be downloaded on a user device, said metadata comprising information about said application that, when received by an ad server, is used by said ad server to select advertising relevant to said application;
placing the smart tag on the application to be made available for download; and
activating the smart tag to communicate with the ad server requesting service of relevant, targeted ads to the user device once the application is transmitted to the user device and upon each invocation thereafter;
wherein the application is activated only after the ad completes.

19. The computer program product of claim 18 further comprising:
tracking ad revenue associated with the application.

20. The computer program product of claim 18 further comprising:
augmenting metadata in the smart tag with information about the user, wherein said information is used by the ad server to select relevant ads.
